(19) United States
(12) Patent Application Publication
(10) Pub. No.: US 2023/0328846 A1
(43) Pub. Date: Oct. 12, 2023

(54) METAL HEATING BODY, METAL HEATING DEVICE, AND METAL HEATING BODY MANUFACTURING METHOD

(71) Applicant: WUHU ALDOC TECH CO., LTD., Anhui (CN)

(72) Inventor: Ruguo HU, Anhui (CN)

(21) Appl. No.: 18/021,122

(22) PCT Filed: Aug. 18, 2021
(86) PCT No.: PCT/CN2021/113228

§ 371 Date: Feb. 13, 2023

(30) Foreign Application Priority Data
Aug. 18, 2020 (CN) 202010830332.8
Aug. 18, 2020 (CN) 202010830351.0
Aug. 18, 2020 (CN) 202010830356.3
Aug. 18, 2020 (CN) 202010830887.2

(51) Int. Cl. H05B 3/40; H05B 3/12; H05B 3/16

(52) U.S. Cl. CPC H05B 3/12; H05B 3/16; H05B 3/40; H05B 2203/017; H05B 2203/019

(57) ABSTRACT

Disclosed in the present invention are a metal heating body, a metal heating device, and a metal heating body manufacturing method. The metal heating body comprises a metal base material and an electric heating layer; the electric heating layer is provided with a heating area and an insulation area; the insulation area isolates the heating area from the metal base material; the metal heating body is provided with at least two electrode layers; the at least two electrode layers are at least partially provided in the heating area or located at two ends of the heating area.

The present disclosure claims the priorities to Chinese patent application No. 2020108303510 titled “METHOD FOR MANUFACTURING METAL HEATING BODY”, filed with CNIPA on Aug. 18, 2020, Chinese patent application No. 2020108303328 titled “METAL HEATING BODY AND METAL HEATING DEVICE”, filed with CNIPA on Aug. 18, 2020, Chinese patent application No. 2020108303563 titled “METAL HEATING BODY AND METAL HEATING DEVICE”, filed with CNIPA on Aug. 18, 2020, Chinese patent application No. 2020108308872 titled “METHOD FOR MANUFACTURING METAL HEATING BODY”, filed with the China National Intellectual Property Administration on Aug. 18, 2020, which are all incorporated herein by reference in their entireties.

### FIELD

The present disclosure relates to the technical field of electric heating, in particular to a metal heating body, a metal heating device and a method for manufacturing the metal heating body.

### BACKGROUND

General electric heating products use resistance wire heating or film heating. The heating component using the resistance wire is filled with magnesium powder and sealed in the metal tube, and the fluid is heated by the heating tube. The heating component in the film heating method is to print the metal resistance film on the heating component. Before printing the metal resistive film, an insulating layer needs to be printed first, and the metal resistive film needs to be through multiple printings and sintering. The multilayer printed structure is easy to crack and peel off after multiple thermal shocks.

### SUMMARY

The object of the present application is to provide a metal heating body, a metal heating device and a method for manufacturing the metal heating body, where the metal heating body is resistant to thermal shock and has a stable structure.

In order to achieve the above object, the technical solutions are provided. A metal heating body includes a metal substrate and an electric heating layer, where the electric heating layer is fixed to the metal substrate, and the electric heating layer includes an insulating region and a heating region in a direction away from the metal substrate, the insulating region and the heating region are in an integral structure, and the insulating region is configured to isolate the heating region with the metal substrate, and the metal heating body further includes two electrode layers, where a part of the insulating region is located between the electrode layers and the metal substrate, at least part of one electrode layer is electrically connected to one end of the heating region, and at least part of the other electrode layer is electrically connected to the other end of the heating region.

In order to achieve the above object, the technical solutions are provided. A metal heating device includes a fixation frame and the metal heating body according to the above technical solutions, where the metal heating body is a metal tube, and the metal heating body is fixed on the fixation frame, the metal heating device has an inlet and an outlet, and the inlet and the outlet are in communication with an inner cavity of the metal tube.

In order to achieve the above purpose, the technical solutions are provided. A method for manufacturing a metal heating body includes:
providing a metal substrate;
fixing an insulating material to the metal substrate so as to form an insulating blank layer;
combining a nano heating material with a part of the insulating material of the insulating blank layer so as to form an electric heating layer, where the electric heating layer includes an insulating region and a heating region; and
fixing an electrode paste material to the electric heating layer so as to form an electrode layer.

In order to achieve the above purpose, the technical solutions are provided. A method for manufacturing a metal heating body includes:
providing a metal substrate;
anodizing the metal substrate to form a metal oxide thin film region on the surface of the metal substrate;
combining the nano heating material with a part of the metal oxide in the metal oxide thin film region so as to form an electric heating layer, where the electric heating layer includes an anodized thin film region and a heating region; and
fixing an electrode paste material to the electric heating layer to form an electrode layer.

According to the above technical solutions, the metal heating body includes a metal substrate and an electric heating layer, the electric heating layer is fixed with the metal substrate, the electric heating layer includes an insulating region and a heating region, and the insulating region and the heating region are in an integral structure, and the structure is stable, and thus it is not easy to spall off, crack, and has stable performance under thermal shock.

According to the above manufacturing method, the nano heating material is combined with a part of the insulating material of the insulating blank layer so as to form an electric heating layer, and the electric heating layer includes an insulating region and a heating region; the prepared metal heating body includes a heating region and an insulating region, and the structure is stable, and thus it is not easy to spall off, crack, and has stable performance under thermal shock.

According to the above manufacturing method, a metal oxide thin film region is formed on the surface of the metal substrate by anodizing the metal substrate; the nano heating material is combined with a part of the metal oxide in the metal oxide thin film region to form an electric heating layer, the electric heating layer includes an anodized thin film region and a heating region; the prepared metal heating body includes a heating region and an anodized thin film region, and the structure is stable, and thus it is not easy to spall off, crack, and has stable performance under thermal shock.

### BRIEF DESCRIPTION OF THE DRAWINGS

FIG. 1 is a schematic structural view of a metal heating body according to an embodiment of the present disclosure;

FIG. 2 is a schematic cross-sectional view of a metal heating body according to an embodiment of the present disclosure;

FIG. 3 is a schematic cross-sectional view of a metal heating body according to another embodiment of the present disclosure;

FIG. 4 is a schematic cross-sectional view of a metal heating body according to another embodiment of the present disclosure;

FIG. 5 is a schematic structural view of an existing film heating tube;

FIG. 6 is a schematic structural view of an existing film heating sheet;

FIG. 7 is a schematic view of a metal heating device according to an embodiment of the present disclosure;

FIG. 8 is a flow chart of a method for manufacturing a metal heating body according to the present disclosure;

FIG. 9 is a schematic cross-sectional view of a metal heating body according to another embodiment of the present disclosure;

FIG. 10 is a schematic cross-sectional view of a metal heating body according to another embodiment of the present disclosure;

FIG. 11 is a schematic cross-sectional view of a metal heating body according to another embodiment of the present disclosure; and

FIG. 12 is a flow chart of a method for manufacturing another metal heating body according to the present disclosure.

### DETAILED DESCRIPTION

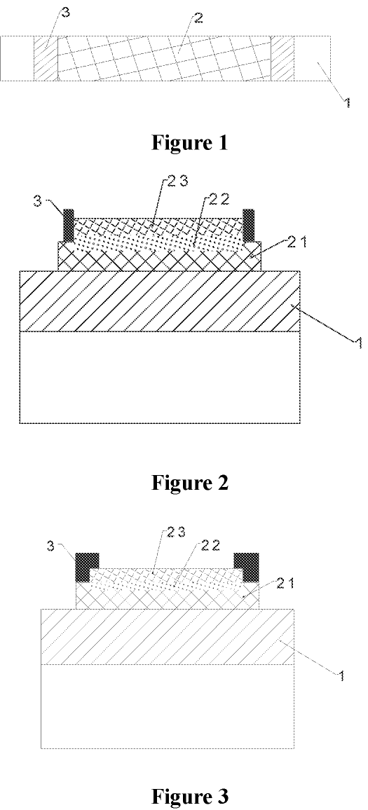

Referring to FIGS. 1 to 4, FIG. 1 shows a schematic structural view of a metal heating body. The metal heating body includes a metal substrate 1 and an electric heating layer 2. The electric heating layer 2 is fixed to the metal substrate 1, which means that the electric heating layer does not spall off after being attached to the metal substrate 1, and the metal substrate 1 and the electric heating layer 2 are maintained as an integral structure.

In a direction away from the metal substrate, the electric heating layer 2 includes a heating region 23 and an insulating region 21, the insulating region 21 and the heating region 23 are integral structures, and the insulating region 21 is configured to isolate the heating region 23 and the metal substrate 1. Herein, the integral structure of the insulating region 21 and the heating region 23 refers to a structure in which the insulating region 21 and the heating region 23 are in the same layer. The direction away from the metal substrate refers to the direction radiating outward from the center of the metal substrate.

The metal heating body further includes two electrode layers 3, a part of the insulating region 21 is located between the electrode layer 3 and the metal substrate 1, where at least part of one electrode layer 3 is electrically connected to one end of the heating region 23, and at least part of the other electrode layer 3 is electrically connected to the other end of the heating region. Of course, when the metal heating body is a metal plate or a metal sheet, etc., and the heating region 23 is in a circular or square or other irregular structure, one end of the heating region represents a certain position of a circle or a square or other irregular structure, and other end of the heating region represents another position of a circle or square or other irregular structure. The number of the electrode layers 3 may be three or more.

The insulating region 21 and the heating region 23 are made of different material. The insulating region 21 includes a fusion region 22, and the fusion region 22 is fused with the same material as that of the heating region 23.

The formation of the electric heating layer 2 includes the insulating material is fixed to the metal substrate preferably by screen printing so as to form an insulating blank layer, and the nano heating material is combined with a part of the insulating material of the insulating blank layer preferably by vacuum evaporation or vapor deposition or ion sputtering or plasma plating, etc. so as to form an electric heating layer, which includes an insulating region 21 and a heating region 23. Since the insulating region 21 has a fusion region 22, in the fusion region 22, and due to the fusion of the nano heating material and the insulating material in the fusion region 22, thus the insulating region 21 and the heating region 23 form a layer of dense structure, and the structure is stable, so that it is not easy to spall off, crack, and has stable performance under thermal shock.

The metal substrate 1 may be a metal tube, a metal plate or a metal sheet, etc. The thickness of the metal substrate 1 is between 0.05 mm to 3 mm; the electric heating layer 2 continuously and uninterruptedly covers the surface of the metal substrate 1, and the heating region 23 also continuously and uninterruptedly covers the surface of the metal substrate 1, in other words, the heating region 23 covers the metal substrate 1 in one-piece type. Herein, the one-piece type means that the heating region 23 is not divided and is in the form of a whole piece. Since the heating region 23 covers the metal substrate 1 in one-piece type, when the metal heating body is powered on, the whole heating region 23 is rapidly heated, so that the metal substrate 1 covered by the whole heating region 23 has a similar temperature, and thus, on the one hand, the metal substrate 1 can uniformly heat the fluid to be heated, and, on the other hand, the uniformly heated heating region 23 exerts a relatively uniform stress on the metal substrate 1, which is beneficial to the crack resistance and deformation resistance of the metal substrate 1.

Specifically, when the metal substrate 1 is a metal tube, the electric heating layer 2 may be continuously and uninterruptedly coated on the outer periphery of the metal tube, the electric heating layer 2 is located in the middle region of the metal tube, and the covering region of the electric heating layer 2 accounts for 60% to 90% of the surface area of the metal tube. When the electric heating layer 2 is located on the inner surface of the metal tube, the covering region of the electric heating layer 2 accounts for 60% to 90% of the inner surface area of the metal tube. When the electric heating layer 2 is located on the outer surface of the metal tube, the covering region of the electric heating layer 2 accounts for 60% to 90% of the outer surface area of the metal tube.

When the metal substrate 1 is a metal plate or a metal sheet, the electric heating layer 2 may continuously and uninterruptedly cover the surface of the metal plate or the metal sheet, the electric heating layer 2 is located in the middle region of the metal tube, and the covering region of the electric heating layer 2 accounts for 60% to 90% of the surface area of the metal tube.

The resistivity of the metal heating body is 85% to 95%, and the resistivity is defined to be a ratio of the working resistance to the normal temperature resistance. For example, when the metal heating body is not working, the resistance is R1. When the metal heating body is powered on and heated, the working resistance is R2, and the resistivity = R2/R1. The resistivity of the metal heating body is close to 1, which can make the heating efficiency of the metal heating body higher during heating. At the same time, since the resistance of the metal heating body does not change much between the work temperature and the normal temperature, it is easier to control the temperature of the metal heating body.

The power density of the heating region of the metal heating body may be in the range of 5 W/cm² to 200 W/cm², and the power density is defined to be a ratio of the power to the area of the heating region. The power density range is very broad and may be applied to many products. In a case that the metal substrate 1 is a metal tube, the diameter of the metal tube is 6 mm to 80 mm, the heating power of the metal tube may be 200 W to 10000 W, and the power density of the heating region of the metal tube is 30 W/cm² to 180 W/cm². The power density is high, so that high power can be achieved with a small heating region. In the case that high power can be achieved to meet the needs of the application, the overall structure of the metal heating body can be made small and compact.

The thickness of the fusion region 22 of the metal heating body is in the range of 0.01 µm to 10 µm, the thickness of the heating region 23 is in the range of 1 µm to 30 µm, and the thickness of the insulating region 21 is in the range of 10 µm to 210 µm. Although the thickness of the heating region 23 is in the range of 1 µm to 30 µm, which is very small, since the insulating region 21 has a fusion region 22, and the thickness of the fusion region 22 is in the range of 0.01 µm to 10 µm, and thus the connection between the heating region 23 and the insulating region 21 is strongly guaranteed, which makes the structure of the electric heating layer 2 stable and not easy to spall off and crack. In addition, due to the existence of the fusion region 22, the nano heating material in the fusion region 22 is fused with the insulating material, which improves the metal thermal conductivity of the insulating region, further makes the thickness of the insulating region 21 smaller, which is within the range of 10 µm to 210 µm, so that the thickness of the electric heating layer 2 is very thin, which is also beneficial to the uniformity of the electric heating layer 2.

Metal substrates include stainless steel, iron, titanium, titanium alloys, aluminum, aluminum alloys, and the like.

The nano heating materials include, for example, at least one of TIO metal oxide nano heating material, LiO metal oxide nano heating material, ZnO metal oxide nano heating material, In₂O₃; metal oxide nano heating material, SnO₂ metal oxide nano heating material, Ca₂InO₄ metal oxide nano heating material, graphene nanometer heating material, and nano silver heating material.

Specifically, nano heating materials include, for example, two or more of TIO metal oxide nano heating material, LiO metal oxide nano heating material, ZnO metal oxide nano heating material, In₂O₃; metal oxide nano heating material, SnO₂ metal oxide nano heating material, Ca₂InO₄ metal oxide nano heating material, graphene nano heating material, and nano silver heating material. For example, TIO metal oxide nano heating material and Ca₂InO₄ metal oxide nano heating material, ZnO metal oxide nano heating material and In₂O₃; metal oxide nano heating material, TIO metal oxide nano heating material and LiO metal oxide nano heating material, SnO₂ metal oxide nano heating material, Ca₂InO₄ metal oxide nano heating material and nano silver heating material, SnO₂ metal oxide nano heating material, Ca₂InO₄ metal oxide nano heating material and graphene nano heating material, etc.

Specifically, in an embodiment, the insulating region 21 includes a non-metal sinterable and curable glass body or an organic coating material or an electronic paste.

The electrode layer 3 of the electric heating layer 2 is fixed to the electric heating layer by screen printing and sintering with the silver paste, and the sintering temperature is 120° C. to 180° C. Referring to FIG. 3, the electrode layer 3 may partially cover the heating region 23, so that the electrode layer 3 and the heating region 23 are better electrically connected. Referring to FIG. 2, the electrode layer 3 may be in close contact with the heating region 23, and the power is supplied to the heating region 23 by the electrode layer 3. The distance between the electrode layer 3 and the metal conductive part is farther than the distance between the insulating region 21 and the metal conductive part, so as to ensure the electric safety distance.

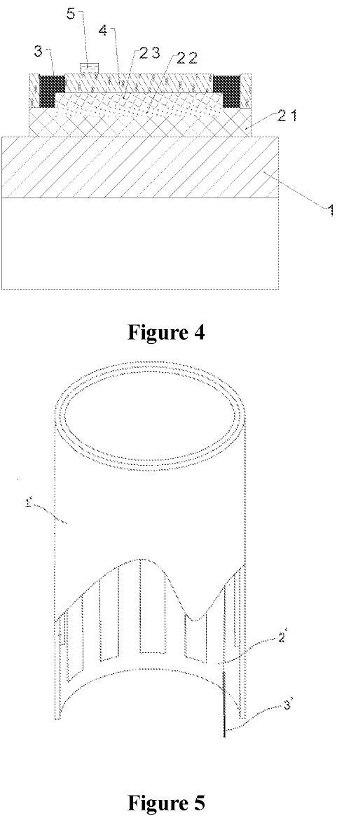

Referring to FIG. 4, the metal heating body may further include an electric insulating layer 4 covering the electrode layer 3 and the heating region 23. The electric insulating layer 4 is formed by fixing an insulating material to the heating region 23 by screen printing and sintering.

The metal heating body further includes a sintered coating 5, which is made of a negative temperature coefficient resistance material, the sintered coating 5 is located on the electric insulating layer 4, and the sintered coating 5 of the negative temperature coefficient resistance material is a sintered coating 5 with a NTC property.

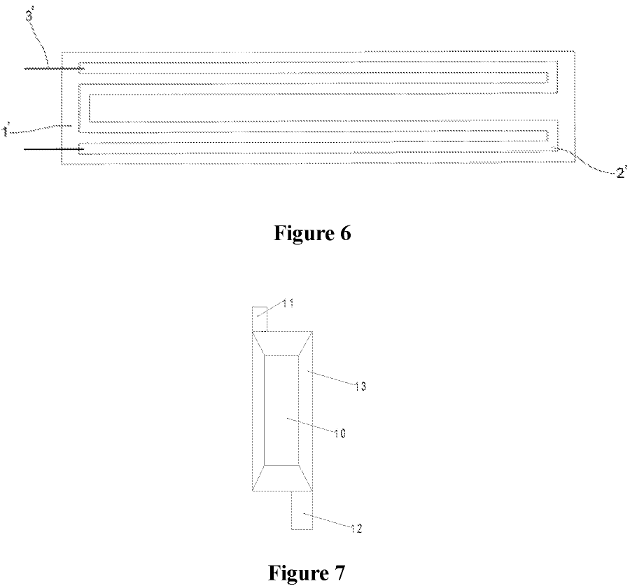

For comparison, FIGS. 5 and 6 are structural views of the existing thick-film heating film. The heating element shown in FIGS. 5 and 6 includes a substrate 1′, a heating film 2′ and an electrode 3′. As shown in FIGS. 5 and 6, the heating films 2′ are arranged at intervals. The heating temperature is high in the region where the metal film is provided, and the heating temperature is low in the region where the metal film is not provided, so that the substrate is easily broken, and the uniformity of the fluid heating is also poor.

The insulating layer and heating film of this thick-film heating structure are formed by multiple screen printing and curing, so the thickness of the heating film and the thickness of the insulating layer are relatively thick, and the thickness of the insulating layer is about 100 µm. Since the heating film and the insulating layer are formed by multiple screen printing, the heat of the heating film is transferred to the substrate through the insulating layer after being heated. Due to the large thickness of the insulating layer, the heat transfer efficiency is reduced and the consistency of the transfer of the heating film to the substrate is also affected. In addition, the heating film is arranged at intervals, which further affects the heat transfer efficiency, and easily causes the deformation of the substrate and the peeling of the heating film.

Referring to FIG. 7, it shows a schematic structural view of a metal heating device. The metal heating device includes a metal heating body 10 and a fixation frame 13. The metal heating body 10 is a metal tube. The metal heating body 10 is fixed in the fixation frame 13. The metal heating device has an inlet 11 and an outlet 12. The inlet 11 and the outlet 12 are communicated with an inner cavity of the metal tube. The metal heating device may be applied to various heating places with instant heating needs.

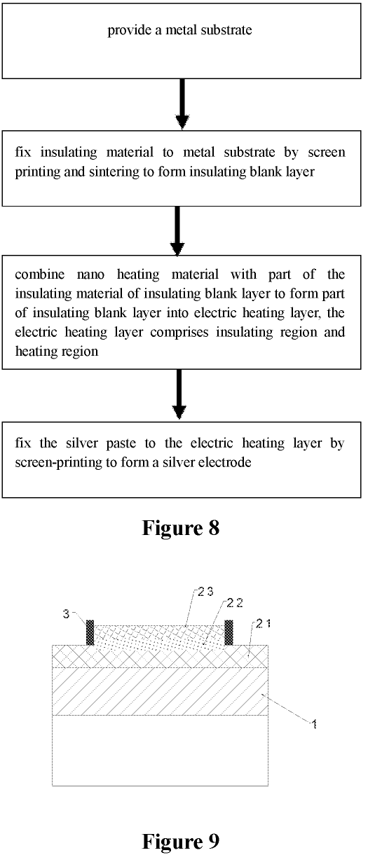

FIG. 8 shows a method for manufacturing the metal heating body, which includes the following steps:
a metal substrate is provided;
an insulating material is fixed to the metal substrate to form an insulating blank layer;
a nano heating material is combined with a part of the insulating material of the insulating blank layer to form an electric heating layer, and the electric heating layer includes an insulating region and a heating region; and
an electrode paste material is fixed to the electric heating layer to form an electrode layer.

The insulating region and the heating region form an integral structure, the insulating region includes a fusion region, and the fusion region is fused with nano heating materials. The insulating region has a fusion region. Because the nano heating material and the insulating material are fused in the fusion region, the insulating region with the fusion region and the heating region form a layer of dense structure, and the structure is stable, which makes it not easy to spall off and crack under the thermal shock, and has stable performance.

The sintering temperature for fixing the insulating material to the metal substrate by screen printing is 500° C. to 1000° C. At this temperature, the insulating material may be printed more firmly on the metal substrate.

The insulating material is, for example, a non-metal sinterable and curable glass body or an organic coating material or an electronic paste.

The nano heating material is combined with a part of the insulating material of the insulating blank layer by vacuum evaporation or vapor deposition or ion sputtering or plasma plating. The nano heating materials include, for example, at least one of TIO metal oxide nano heating material, LiO metal oxide nano heating material, ZnO metal oxide nano heating material, In₂O₃; metal oxide nano heating material, SnO₂ metal oxide nano heating material, Ca₂InO₄ metal oxide nano heating material, graphene nano heating material, and nano silver heating material.

Specifically, the nano heating materials include, for example, two or more of TIO metal oxide nano heating material, LiO metal oxide nano heating material, ZnO metal oxide nano heating material, In₂O₃; metal oxide nano heating material, SnO₂ metal oxide nano heating material, Ca₂InO₄ metal oxide nano heating material, graphene nano heating material, and nano silver heating material. For example, TIO metal oxide nano heating material and Ca₂InO₄ metal oxide nano heating material, ZnO metal oxide nano heating material and In₂O₃; metal oxide nano heating material, TIO metal oxide nano heating material and LiO metal oxide nano heating material, SnO₂ metal oxide nano heating material, Ca₂InO₄ metal oxide nano heating material and nano silver heating material, SnO₂ metal oxide nano heating material, Ca₂InO₄ metal oxide nano heating material and graphene nano heating material, etc.

The electrode paste material is specifically selected from silver paste, the fixing method is preferably screen printing and sintering, and the sintering temperature is 120° C. to 500° C.

Further, the insulating material is fixed on the electric heating layer by screen printing and sintering to form an electric insulating layer. The electric insulating layer can be used to block the heating region with the external environment, which is more conducive to ensuring the safety of electricity use.

The negative temperature coefficient resistance material is fixed to the electric insulating layer by sintering to form a sintered coating. The sintered coating has NTC properties, and the temperatures both of the substrate and a fluid to be heated may be measured by the change of resistance in order to achieve a certain degree of temperature control, which is used to ensure the temperature measurement of the metal heating body and improve the electric safety of the metal heating body.

Referring to FIGS. 9 to 11, FIG. 9 shows a schematic structural view of another metal heating body. The metal heating body includes a metal substrate 1 and an electric heating layer 2. The electric heating layer 2 includes an anodized thin film region and a heating region. The anodized thin film region is configured to isolate the heating region and the metal substrate, and the anodized thin film region and the heating region are in an integral structure.

In the present disclosure, the anodized thin film region and the heating region are made of different materials, and the anodized thin film region further includes a fusion region, and the fusion region is fused with the same material as that of the heating region. In this embodiment, the metal substrate 1 is an aluminum substrate 1, and the electric heating layer 2 is fixed to the aluminum substrate 1, and fixation of these two with each other means that the electric heating layer does not spall off after being attached to the aluminum substrate 1 and maintains as an integral structure. The anodized thin film region is specifically an aluminum oxide thin film region 21 and a fusion region 22.

In the direction away from the aluminum substrate, the electric heating layer 2 has an anodized thin film region and a heating region 23, the anodized thin film region and the heating region 23 are in an integral structure, and the anodized thin film region is configured to isolate the heating region 23 with the aluminum substrate 1. Herein, the anodized thin film region and the heating region 23 are in the integral structure, which means that the anodized thin film region and the heating region 23 are in one single layer structure. The direction away from the aluminum substrate refers to the direction radiating outward from the center of the aluminum substrate.

Herein, the aluminum substrate includes materials such as aluminum and aluminum alloys.

The metal heating body includes two electrode layers 3, a part of the aluminum oxide thin film region 21 is located between the electrode layer 3 and the aluminum substrate 1, and at least part of one electrode layer 3 is electrically connected to one end of the heating region 23, and at least part of the other electrode layer 3 is electrically connected to the other end of the heating region. Of course, in case that the metal heating body is a metal plate or a metal sheet, etc., and the heating region 23 is in a circular or square or other irregular structure, one end of the heating region represents a certain position of a circle or a square or other irregular structure, and the other end of the heating region represents another position of a circular or square or other irregular structure, that is, one end and the other end herein prefers to be the ends to which the electric current flows, and the number of electrode layers 3 may be three or more.

The aluminum oxide thin film region 21 is formed by anodizing the aluminum substrate so as to form an aluminum oxide thin film on the surface of the aluminum substrate. The aluminum oxide thin film is dense and continuous. The nano materials are covered on the aluminum oxide thin film by deposition, ion sputtering or plasma plating, etc., so as to form the electric heating layer 2, and the electric heating layer includes an aluminum oxide thin film region 21 and a heating region. The aluminum oxide thin film region 21 continuously and uninterruptedly covers the surface of the aluminum substrate in one piece type. Due to the high hardness of aluminum oxide, the aluminum oxide thin film region 21 is configured as a electrical insulation between the aluminum substrate and the fusion region and the heating region in the structure of the metal heating body, so as to ensure the electrical safety of the metal heating body.

Due to the fusion of the nano materials and the aluminum oxide in the fusion region 22, the aluminum oxide thin film region 21 and the heating region 23 form a layer of dense structure with a stable structure, which makes it not easy to spall off and crack under the thermal shock, and has stable performance.

The aluminum substrate 1 may be an aluminum tube, an aluminum plate, an aluminum sheet, etc., and the thickness of the aluminum substrate 1 is between 0.05 mm to 5 mm; the heating region 23 continuously and uninterruptedly covers the surface of the aluminum substrate 1 in one piece type. Herein, the one piece type means that the heating region 23 is not divided and is in the form of a whole piece. Since the heating region 23 covers the aluminum substrate 1 in one piece type, when the metal heating body is powered on, the whole heating region 23 is rapidly heated, so that the aluminum substrate 1 covered by the whole heating region 23 has a similar temperature, and thus, on the one hand, the aluminum substrate 1 can uniformly heat the fluid to be heated, and, on the other hand, the uniformly heated heating region 23 exerts a relatively uniform stress on the aluminum substrate 1, which facilitates the crack resistance and deformation resistance of the aluminum substrate 1.

Specifically, in case that the aluminum substrate 1 is an aluminum tube, the heating region 23 continuously and uninterruptedly covers the outer periphery of the aluminum tube, the heating region 23 is located in the middle region of the aluminum tube, and the covering region of the heating region 23 accounts for 60% to 90% of the surface area of the aluminum tube. In case that the heating region 23 is located on the inner surface of the aluminum tube, the covering region of the heating region 23 accounts for 60% to 90% of the inner surface region of the aluminum tube. In case that the electric heating layer 2 is located on the outer surface of the aluminum tube, the covering region of the heating region 23 accounts for 60% to 90% of the outer surface region of the aluminum tube.

In case that the aluminum substrate 1 is an aluminum plate or an aluminum sheet, the heating region 23 may continuously and uninterruptedly cover the surface of the aluminum plate or the aluminum sheet. In case that the electric heating layer 2 is located in the middle region of the aluminum plate or the aluminum sheet, the covering region of the heating region 23 accounts for 60% to 90% of the surface area of the aluminum plate or aluminum sheet.

The resistivity of the heating region of the metal heating body is 85% to 115%, and the resistivity refers to a ratio of the working resistance to the normal temperature resistance. For example, when the metal heating body is not working, the resistance is R1. When the metal heating body is powered on and heated, the working resistance is R2, and the resistivity = R2/R1. The resistivity of the metal heating body is close to 1, which can make the heating efficiency of the metal heating body higher during heating. At the same time, since the resistance of the metal heating body does not change much between the work temperature and the normal temperature, it is easier to control the temperature of the metal heating body.

The power density of the metal heating body may be in the range of 1 W/cm² to 150 W/cm², and the power density refers to a ratio of the power to the area of the heating region. The power density range is very broad and may be applied to many products. In case that the aluminum substrate 1 is an aluminum tube, the diameter of the aluminum tube is 6 mm to 80 mm, the heating power of the aluminum tube may be 10 W to 3000 W, and the power density of the heating region of the aluminum tube is 1 W/cm² to 100 W/cm². The power density is high, so that high power can be achieved with a small heating region. In the case that high power can be achieved to meet the needs of the application, the overall structure of the metal heating body can be made small and compact. Since the metal heating body has an aluminum substrate, and the electric heating layer fixed on the aluminum substrate has an aluminum oxide thin film region and a heating region, the power density of the heating region can be very small, for example, in case of 1 W/cm² to 10 W/cm², it can be driven by batteries, etc.

The thickness of the fusion region 22 of the metal heating body is in the range of 0.01 µm to 10 µm, the thickness of the heating region 23 is in the range of 1 µm to 20 µm, and the thickness of the anodized thin film region is in the range of 3 µm to 40 µm. Although the thickness of the heating region 23 is in the range of 1 µm to 20 µm, the thickness is very small, since the aluminum oxide thin film region 21 has a fusion region 22, and the thickness of the fusion region 22 is in the range of 0.01 µm to 10 µm, the connection between the heating region 23 and the anodized thin film region are strongly guaranteed, which makes the structure of the heating region stable and not easy to spall off and break. In addition, since the aluminum oxide thin film region 21 is formed by anodizing the aluminum substrate, the thickness may be very small. Meanwhile, due to the existence of the fusion region 22, the nano materials in the fusion region 22 are fused with the aluminum oxide, which improves the metal thermal conductivity of the anodized thin film region, further makes the thickness of the anodized thin film region smaller, which is within the range of 3 µm to 40 µm, so that the thickness of the electric heating layer 2 is very thin, which is also beneficial to the uniformity of the electric heating layer 2.

Specifically, in an embodiment, the heating region 23 includes SnO₂ metal oxide nano material, and the aluminum oxide thin film region 21 includes a non-metal sinterable and curable glass body or an organic coating material.

In another embodiment, the heating region 23 includes graphene nano material, and the aluminum oxide thin film region 21 includes a non-metal sinterable and curable glass body or an organic coating material.

As other embodiments, the heating region 23 may include at least one of TIO metal oxide nano heating material, In₂O₃ metal oxide nano heating material, ZnO metal oxide nano heating material, LiO metal oxide nano heating material, SnO₂ metal oxide nano heating material, Ca₂InO₄ metal oxide nano heating material, graphene nano heating material and nano silver heating material. For example, the heating region 23 includes two or more of TIO metal oxide nano heating material, In₂O₃ metal oxide nano heating material, ZnO metal oxide nano heating material, LiO metal oxide nano heating material, SnO₂ metal oxide nano heating material, Ca₂InO₄ metal oxide nano heating material, graphene nano heating material and nano silver heating material, which makes the conductivity of the heating region stronger. For example, TIO metal oxide nano heating material and Ca₂InO₄ metal oxide nano heating material, ZnO metal oxide nano heating material and In₂O₃ metal oxide nano heating material, TIO metal oxide nano heating material and LiO metal oxide nano heating material, SnO₂ metal oxide nano heating material, Ca₂InO₄ metal oxide nano heating material and nano silver heating material, SnO₂ metal oxide nano heating material, Ca₂InO₄ metal oxide nano heating material and graphene nano heating material, etc.

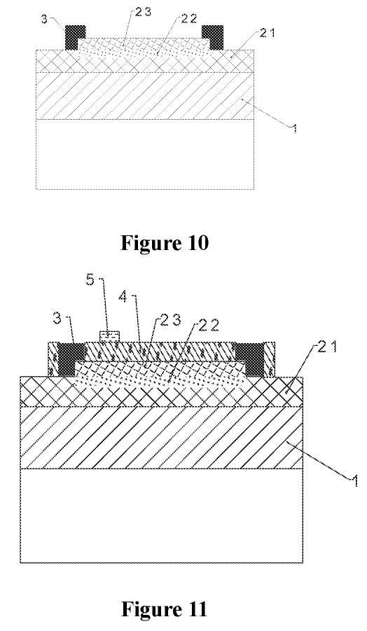

The electrode layer 3 of the electric heating layer 2 is fixed to the electric heating layer by screen printing and sintering of the silver paste, and the sintering temperature is 120° C. to 500° C. Referring to FIG. 10, the electrode layer 3 may partially cover the heating region 23, so that the electrode layer 3 and the heating region 23 are better electrically connected. Referring to FIG. 9, the electrode layer 3 may be in close contact with the heating region 23, and power is supplied to the heating region 23 through the electrode layer 3. The distance between the electrode layer 3 and the metal conductive part is farther than the distance between the aluminum oxide thin film region 21 and the metal conductive part, so as to ensure the electric safety distance.

Referring to FIG. 11, the metal heating body may further include an electric insulating layer 4 covering the electrode layer 3 and the heating region 23. The electrically insulating layer 4 is formed by fixing an insulating material on the heating region 23 by screen printing and sintering.

The metal heating body further includes a sintered coating 5, which is made of a negative temperature coefficient resistance material, the sintered coating 5 is located on the electric insulating layer 4, and the sintering coating 5 of the negative temperature coefficient resistance material is a sintered coating 5 with a NTC property.

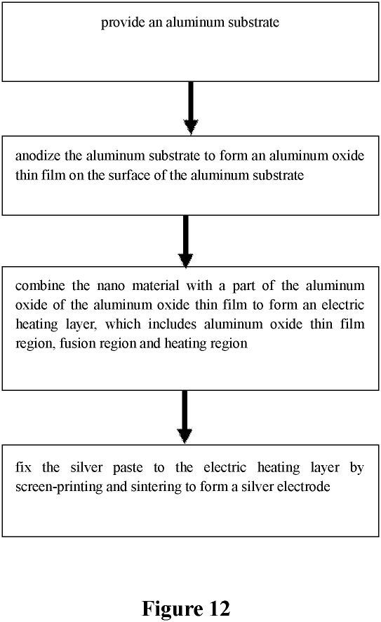

FIG. 12 shows a method for manufacturing the metal heating body, which includes the following steps:
a metal substrate is provided; the metal substrate is specifically selected from aluminum substrates, the aluminum substrate includes aluminum and aluminum alloy materials, and the aluminum substrate includes shapes such as aluminum tubes, aluminum plates, and aluminum sheets;
the aluminum substrate is anodized to form an aluminum oxide thin film on the surface of the aluminum substrate;
the nano heating material is combined with a part of the aluminum oxide of the aluminum oxide thin film to form an electric heating layer, the electric heating layer includes an anodized thin film region, a fusion region and a heating region; and
the silver paste is fixed on the electric heating layer by screen-printing and sintering to form a silver electrode.

The aluminum oxide thin film is formed by anodizing the aluminum substrate. The aluminum oxide thin film forms a layer of dense, continuous and uninterrupted thin film on the surface of the aluminum substrate, and the hardness of aluminum oxide is high. When the nano heating material is combined with the part of aluminum oxide of the aluminum oxide thin film, an electric heating layer is formed, and the aluminum oxide of the aluminum oxide film in contact with the nano heating material and the nano heating material form a fusion region, so that the aluminum oxide thin film and the nano heating material form a layer of electric heating layer structure. The electric heating layer includes an aluminum oxide thin film region, a fusion region and a heating region, so that the metal heating body has the properties of thermal shock resistance and stable structure.

In addition, the aluminum oxide thin film region is also configured as an electric insulation between the aluminum substrate and the fusion region and the heating region in the structure of the metal heating body, so as to ensure the safety of electricity use of the metal heating body.

Before anodizing the aluminum substrate, the aluminum substrate needs to be pretreated; the pretreatment includes the following steps:

the aluminum substrate is rinsed; first, the impurities attached to the surface of the aluminum substrate are removed with tap water, and then rinse with deionized water to reduce the influence of the residual impurities on the surface of the aluminum substrate on the subsequent anodization.

Alkaline etching treatment is performed on the aluminum substrate. If the aluminum substrate is stored in the external environment for a long time, there may be oxides on the surface of the aluminum substrate. Therefore, the aluminum substrate needs to be treated before anodizing. The metal surface of the aluminum substrate is exposed. Specifically, the aluminum substrate is soaked in sodium hydroxide or potassium hydroxide solution for a certain period of time.

For example, the aluminum substrate is soak in sodium hydroxide solution for 60 seconds at 50±10° C. For example, the aluminum substrate is soak in potassium hydroxide solution for 50 seconds at 60±10° C.

After the alkaline etching treatment, the aluminum substrate is rinsed with water, or the aluminum substrate is rinsed with tap water first, and then subjected to a secondary rinse with deionized water.

After the surface of the substrate is subjected to alkaline etching treatment, some substances in the alloy material, such as iron, manganese, copper, magnesium, etc. which are insoluble in alkali, remain on the surface of the workpiece to form a layer of gray-black loose substances, which will affect the subsequent process. The substances need to be removed, and the removal method may be manual erasing, but the efficiency is low and the effect is poor, so the chemical solution method may be used in the present technical solution, which can make the surface of the aluminum substrate show a crystalline structure with metallic luster and make it fully activated, it can also be neutralized with residual lye after alkaline etching.

Specifically, the activation treatment includes the steps:

the aluminum substrate is soaked in the acid solution for a preset time.

In a specific embodiment, the acid solution may be selected from nitric acid, sulfuric acid, acetic acid or phosphoric acid.

According to the condition of the aluminum substrate surface after the alkaline etching treatment, an acid solution with a suitable concentration and soaking time may be selected.

The aluminum substrate is rinsed with tap water and deionized water after soaking.

Specifically, first the aluminum substrate is rinsed with tap water, then rinsed with tap water with pH > 6, and finally rinsed with pure water with pH > 5 more than one time.

During the anodizing treatment, the metal substrate is soaked in an acid solution with a set temperature and a set concentration, and the anodizing treatment is carried out with a current of a set density.

The acid solution may be a sulfuric acid solution or a mixed solution of sulfuric acid; the set temperature is in the range of 10° C. to 50° C.; and the set density of the current is in the range of 0.5 A/dm² to 2 A/dm².

In a specific embodiment, the acid solution may include a mixed solution of sulfuric acid and oxalic acid, and the acid solution includes nickel and iron metal salts.

After anodizing, the metal substrate after anodizing treatment needs to be cleaned. First the metal substrate is rinsed with tap water, then rinsed with tap water with pH > 6, and finally rinsed with pure water with pH > 5 for more than one time.

After anodizing treatment, an aluminum oxide thin film is formed on the surface of the aluminum substrate, which is heated to 150° C. to 800° C., and the nano heating material is combined with part of the aluminum oxide of the aluminum oxide thin film by vacuum evaporation or vapor deposition or ion sputtering or plasma plating. The nano heating materials include, for example, at least one of TIO metal oxide nano heating material, In₂O₃ metal oxide nano heating material, ZnO metal oxide nano heating material, LiO metal oxide nano heating material, SnO₂ metal oxide nano heating material, Ca₂InO₄ metal oxide nano heating materials, graphene nano heating material, and nano silver heating material.

Specifically, nano heating materials include, for example, two or more of TIO metal oxide nano heating material, LiO metal oxide nano heating material, ZnO metal oxide nano heating material, In₂O₃ metal oxide nano heating material, SnO₂ metal oxide nano heating material, Ca₂InO₄ metal oxide nano heating material, graphene nano heating material, and nano silver heating material. For example, TIO metal oxide nano heating material and Ca₂InO₄ metal oxide nano heating material, ZnO metal oxide nano heating material and In₂O₃ metal oxide nano heating material, TIO metal oxide nano heating material and LiO metal oxide nano heating material, SnO₂ metal oxide nano heating material, Ca₂InO₄ metal oxide nano heating material and nano silver heating material, SnO₂ metal oxide nano heating material, Ca₂InO₄ metal oxide nano heating material and graphene nano heating material, etc.

Through the deposition of the nano heating material, the aluminum oxide thin film is formed into an electric heating layer, including a fusion region where the nano heating material and aluminum oxide are fused, the fusion region is configured to isolate the heating region with the anodized thin film region. The thickness of the fusion region is in the range of 0.01 µm to 10 µm, the thickness of the heating region is in the range of 1 µm to 20 µm, and the thickness of the aluminum oxide thin film is in the range of 2 µm to 30 µm.

The curing and sintering temperature for screen printing and sintering the silver paste so as to be fixed to the electric heating layer is 120° C. to 600° C. There are at least two silver electrodes, one is located on one side of the heating region and is electrically connected to the heating region, and the other is located on the other side of the heating region and is electrically connected to the heating region.

Further, the insulating material is fixed on the outside of the electric heating layer by screen printing and sintering so as to form an electric insulating layer. The electric insulating layer can be used to block the heating region with the external environment, which is more beneficial to ensuring the safety of electricity use. The insulating material is, for example, a non-metal sinterable and curable glass body or an organic coating material.

The negative temperature coefficient resistance material is sintered to be fixed on the electric insulating layer to form a sintered coating. The sintered coating has NTC properties, and the temperatures both of the substrate and a fluid to be heated may be measured with the variation of resistance to achieve a certain degree of temperature control, which is used to ensure the temperature measurement of the metal heating body and improve the electric safety of the metal heating body.

The metal heating body formed by the above-mentioned manufacturing method of the metal heating body may have a tubular structure, a plate structure or a sheet structure.

In order to further understand the present disclosure, the above solutions provided by the present disclosure will be described in detail below in conjunction with the embodiments, and the protection scope of the present disclosure is not limited by the following embodiments.

### Embodiment 1

A stainless steel tube with a diameter of 30 mm and a thickness of 3 mm is provided and the stainless steel tube is at 304 food grade.

The electronic paste is fixed on the outer periphery of the stainless steel tube by screen printing and sintered at 700±50° C. to form an insulating blank layer.

The mixed material containing LiO metal oxide nano heating material and ZnO metal oxide nano heating material is combined with part of the insulating material of the insulating blank layer by plasma plating at a high temperature of 400±50° C. so as to form an electric heating layer. The electric heating layer includes an insulating region and a heating region, the heating region is formed by a mixture of LiO metal oxide nano heating material and ZnO metal oxide nano heating material, the insulating region has a fusion region, and the fusion region is fused with LiO metal oxide nano heating material, ZnO metal oxide nano heating material and the insulating material. The thickness of the fusion region is 5 µm, the thickness of the heating region is 15 µm, and the thickness of the insulating region is 35 µm. During the process of heating the heating region with electricity, the heat is quickly transferred from the heating region to the insulating region through the fusion region, and then transferred to the metal substrate through the insulating region, so that the metal substrate is heated evenly and is not easy to deform, causing the electric heating layer to spall off and crack.

The silver paste screen is printed and sintered at 250±50° C. to be fixed on the electric heating layer to form a silver electrode, thus forming a metal electric heating tube that can be used for heating.

When the prepared metal electric heating tube is heated to 500° C., it is immediately cooled with 20° C. water, the surface of the insulating region does not spall off, and when the metal electric heating tube is applied with 1500 V high voltage, the electric heating layer does not break down and spall off, and has stable performance.

### Embodiment 2

A titanium tube with a diameter of 10 mm and a thickness of 2 mm is provided.

The non-metal sinterable and curable glass body is sintered to be fixed on the outer periphery of the titanium tube by screen printing at 800° C. to 850° C. to form an insulating blank layer.

The mixed material containing ZnO metal oxide nano heating material, In₂O₃ metal oxide nano heating material and SnO₂ metal oxide nano heating material is combined with part of the insulating material of the insulating blank layer by vacuum evaporation at a high temperature of 400±50° C. so as to from an electric heating layer. The electric heating layer includes an insulating region and a heating region, the heating region is formed by a mixture of ZnO metal oxide nano heating material, In₂O₃ metal oxide nano heating material, SnO₂ metal oxide nano heating material, and the insulating region has a fusion region, the fusion region is fused with ZnO metal oxide nano heating material, In₂O₃ metal oxide nano heating material, SnO₂ metal oxide nano heating material and the insulating material. The thickness of the fusion region is 3 µm, the thickness of the heating region is 8 µm, and the thickness of the insulating region is 30 µm. During the process of heating the heating region with electricity, the heat is quickly transferred from the heating region to the insulating region through the fusion region, and then transferred to the metal substrate through the insulating region, so that the metal substrate is heated evenly and is not easy to deform, causing the electric heating layer to spall off and crack.

The silver paste is screen printed and sintered at 300° C. to 350° C. to be fixed to the electric heating layer in order to form a silver electrode, thus forming a metal electric heating tube that can be used for heating.

When the prepared metal electric heating tube is heated to 500° C., it is immediately cooled with 20° C. water, the surface of the insulating region does not spall off, and when the metal electric heating tube is applied with 1500 V high voltage, the electric heating layer does not break down and not spall off, and has stable performance.

### Embodiment 3

An aluminum tube with a diameter of 10 mm and a thickness of 1 mm is provided.

The aluminum tube is pretreated first, and the impurities attached to the surface of the aluminum tube is rinsed with tap water first, and then rinsed with deionized water to reduce the influence of the residual impurities on the surface of the aluminum tube on the subsequent anodization.

Alkaline etching treatment is performed on the aluminum tube. The aluminum tube is placed in an environment of 50±10° C. and soaked in sodium hydroxide solution for 60 seconds. The aluminum tube is rinsed with tap water first, and then subjected to a secondary rinse with deionized water.

The aluminum tube is subjected to an activation treatment. The aluminum tube is soaked in 30% nitric acid for 30 seconds.

After soaking, the aluminum tube is first rinsed with tap water, then rinsed with tap water with pH > 6, and finally rinsed with pure water with pH > 5 for more than one time.

The cleaned aluminum tube is anodized.

The cleaned aluminum tube is soaked in a mixed solution of sulfuric acid and oxalic acid in the range of 10° C. to 50° C., and the acid solution included nickel and iron metal salts.

In an acid solution with a set temperature and a set concentration, anodizing is carried out with a current of 0.5 A/dm² to 2 A/dm² density; an aluminum oxide thin film is formed on the surface of the aluminum tube.

After anodizing, the anodized aluminum tube is rinsed. First, the aluminum tube is rinsed with tap water, then rinsed with tap water with pH > 6, and finally rinsed with pure water with pH > 5 for more than one time.

The aluminum tube formed with the aluminum oxide thin film is heated to 550° C. to 600° C.

The Ca₂InO₄ metal oxide nano heating material and SnO₂ metal oxide nano heating material are combined with part of the aluminum oxide of the aluminum oxide thin film by vacuum evaporation to form an electric heating layer, and the electric heating layer includes an aluminum oxide thin film region, a fusion region and a heating region. The thickness of the aluminum oxide thin film region is 15 µm, the thickness of the fusion region is 8 µm, and the thickness of the heating region is 10 µm.

The silver paste is screen printed and sintered at 350° C. to 400° C. to be fixed on the electric heating layer; thus, an aluminum electric heating tube is formed.

When the prepared metal electric heating tube is heated to 500° C., it is immediately cooled with 20° C. water, the surface of the insulating region does not spall off, and the withstand voltage strength reaches 1500 V.

It should be noted that the above embodiments are only used to illustrate the present application rather than limit the technical solutions described in the present application. For example, the definition of ″front″, ″back″, ″left″, ″right″, ″up″, ″down″, etc., although this specification has described the present application in detail with reference to the above mentioned embodiments, it should be understood by those skilled in the art that those skilled in the art can still combine, modify or equivalently replace the present application. And all technical solutions and improvements that do not depart from the spirit and scope of the present application should be covered within the scope of the claims of the present application.

1. A metal heating body, comprising a metal substrate and an electric heating layer, wherein the electric heating layer is fixed with the metal substrate, and the electric heating layer comprises an insulating region and a heating region in a direction away from the metal substrate, the insulating region and the heating region are in an integral structure, and the insulating region is configured to isolate the heating region with the metal substrate, and
the metal heating body further comprising two electrode layers, wherein a part of the insulating region is located between the electrode layers and the metal substrate, at least part of one electrode layer is electrically connected to one end of the heating region, and at least part of the other electrode layer is electrically connected to the other end of the heating region.

2. The metal heating body according to claim 1, wherein the insulating region and the heating region are made of different materials, the insulating region comprises a fusion region, and the fusion region is fused with a same material as that of the heating region,
a thickness of the fusion region is in a range of 0.01 µm to 10 µm, a thickness of the heating region is in a range of 1 µm to 30 µm, and a thickness of the insulating region is in a range of 10 µm to 210 µm.

3. The metal heating body according to claim 1, wherein the metal substrate comprises a metal tube, a metal plate or a metal sheet, and a thickness of the metal substrate is between 0.05 mm to 3 mm; the electric heating layer covers a surface of the metal substrate in a continuous and uninterrupted manner, and the heating region continuously and uninterruptedly covers the surface of the metal substrate,
and/or wherein a resistivity of the heating region of the metal heating body is 85% to 115%, the resistivity is defined as a ratio of a working resistance to a room temperature resistance,
and/or wherein a diameter of the metal tube is 6 mm to 80 mm, a heating power of the heating region of the metal heating body is 200 W to 10000 W, and a power density of the heating region of the metal heating body is 30 W/cm² to 180 W/cm².

4. (canceled)

5. (canceled)

6. (canceled)

7. The metal heating body according to claim 1, wherein the heating region comprises at least one of TIO metal oxide nano heating material, LiO metal oxide nano heating material, ZnO metal oxide nano heating material, In₂O₃ metal oxide nano heating material, SnO₂ metal oxide nano heating material, Ca₂InO₄ metal oxide nano heating material, graphene nano heating material, and nano silver heating material;
and/or the insulating region comprises a non-metal sinterable and curable glass body or an organic coating material or an electronic paste;
and/or the metal heating body further comprises an electric insulating layer, and the electric insulating layer covers the heating region; the metal heating body further comprises a sintered coating, and the sintered coating is made of a negative temperature coefficient resistance material, the sintered coating is located on the electric insulating layer, and the sintered coating of the negative temperature coefficient resistance material is a sintered coating with a NTC property,
and/or wherein the metal substrate is made of titanium, titanium alloy, stainless steel, iron, aluminum or aluminum alloy.

8. (canceled)

9. The metal heating body according to claim 1, wherein the insulating region comprises an anodized thin film region, the anodized thin film region is configured to isolate the heating region with the metal substrate, the anodized thin film region and the heating region are in an integral structure, and
the metal heating body further comprising two electrode layers, wherein a part of the anodized thin film region is located between the electrode layer and the metal substrate, at least part of one electrode layer is electrically connected to one end of the heating region, and at least part of the other electrode layer is electrically connected to the other end of the heating region,
wherein the metal substrate is an aluminum substrate, and the anodized thin film region comprises an aluminium oxide thin film region and a fusion region.

10. (canceled)

11. (canceled)

12. The metal heating body according to claim 9, wherein the aluminum substrate comprises an aluminum tube or an aluminum plate, and a thickness of the aluminum substrate is between 0.05 mm and 5 mm; the electric heating layer continuously and uninterruptedly covers a surface of the aluminum substrate, and the heating region continuously and uninterruptedly covers the surface of the aluminum substrate.

13. The metal heating body according to claim 12, wherein the aluminum substrate is an aluminum tube, a diameter of the aluminum tube is 6 mm to 80 mm, and a heating power of the aluminum tube is 10 W to 5000 W, and a power density of the heating region of the aluminum tube is 1 W/cm² to 100 W/cm².

14. The metal heating body according to any one of claim 9, wherein a thickness of the fusion region is in a range of 0.01 µm to 10 µm, a thickness of the heating region is in a range of 1 µm to 20 µm, and a thickness of the aluminum oxide thin film is in a range of 3 µm to 40 µm.

15. (canceled)

16. A method for manufacturing a metal heating body, comprising:
providing a metal substrate;
fixing an insulating material to the metal substrate to form an insulating blank layer;
combining a nano heating material with a part of the insulating material of the insulating blank layer so as to form an electric heating layer, wherein the electric heating layer comprises an insulating region and a heating region; and
fixing an electrode paste material to the electric heating layer so as to form an electrode layer.

17. The manufacturing method according to claim 16, wherein the insulating region and the heating region form an integral structure, the insulating region comprises a fusion region, and the fusion region is fused with the nano heating material,
wherein a thickness of the fusion region is in a range of 0.01 µm to 10 µm, a thickness of the heating region is in a range of 1 µm to 30 µm, and a thickness of the insulating region is in a range of 10 µm to 210 µm,
and/or wherein a sintering temperature for fixing the insulating material to the metal substrate by screen printing is 500° C. to 1000° C.,
the insulating material is fixed on the metal substrate by screen printing and sintering to form an electric insulating layer,
and/or the nano heating material is combined with a part of the insulating material of the insulating blank layer by vacuum evaporation or vapor deposition or ion sputtering or plasma plating; wherein the nano heating material is combined with a part of the insulating material of the insulating blank layer in a continuous and uninterrupted manner so as to form the heating region, which covers the surface of the insulating region in a continuous and uninterrupted manner,
wherein a negative temperature coefficient resistance material is sintered so as to be fixed on the electric insulating layer to form a sintered coating.

18. (canceled)

19. (canceled)

20. (canceled)

21. The manufacturing method according to claim 17, wherein the step of fixing the electrode paste material to the electric heating layer is in that:
the silver paste is screen printed and sintered so as to be fixed on the electric heating layer, and the sintering temperature is 120° C. to 500° C.

22. (canceled)

23. (canceled)

24. The manufacturing method according to claim 17, wherein the nano heating material comprises at least one of TIO metal oxide nano heating material, In₂O₃ metal oxide nano heating material, LiO metal oxide nano heating material material, SnO₂ metal oxide nano heating material, ZnO metal oxide nano heating material, Ca₂InO₄ metal oxide nano heating material, graphene nano heating material, and nano silver heating material.

25. (canceled)

26. A method for manufacturing a metal heating body, comprising:
providing a metal substrate;
anodizing the metal substrate so as to form a metal oxide thin film region on the surface of the metal substrate;
combining the nano heating material with a part of the metal oxide in the metal oxide thin film region so as to form an electric heating layer, wherein the electric heating layer comprises an anodized thin film region and a heating region; and
fixing an electrode paste material to the electric heating layer so as to form an electrode layer.

27. The manufacturing method according to claim 26, wherein the metal substrate is an aluminum substrate, and the anodized thin film region comprises an aluminium oxide thin film region and a fusion region,
wherein the aluminum substrate is pretreated before anodizing; the pretreatment comprises the following steps:
rinsing the aluminum substrate; and
soaking the aluminum substrate in sodium hydroxide or potassium hydroxide solution for a certain period of time under an environment of 50±10° C.,
the manufacturing method further comprises an activation treatment, wherein the activation treatment comprises the following steps:
taking out the aluminum substrate from the sodium hydroxide or potassium hydroxide solution, and soaking the aluminum substrate into an acidic solution of nitric acid, phosphoric acid, sulfuric acid or acetic acid; and
rinsing the soaked aluminum substrate with water.

28. (canceled)

29. (canceled)

30. (canceled)

31. The manufacturing method according to claim 26, wherein, during the anodizing treatment, the metal substrate is soaked in an acid solution with a set temperature and a set concentration, and is anodized with a current of a set density;
the acid solution is a sulfuric acid solution or a mixed solution of sulfuric acid;
the set temperature is in a range of 10° C. to 50° C.; and
the set density of the current is in a range of 0.5 A/dm² to 2 A/dm².

32. The manufacturing method according to claim 31, wherein the acid solution comprises a mixed solution of sulfuric acid and oxalic acid, and the acid solution comprises nickel and iron metal salts;
after anodizing, the anodized metal substrate is rinsed, wherein first the metal substrate is rinsed with tap water, then rinsed with tap water with pH > 6, and finally rinsed with pure water with pH > 5 for more than one time.

33. The manufacturing method according to claim 27, further comprising the following steps:
heating the metal substrate formed with the metal oxide thin film to 150° C. to 800° C.; and
combining the nano heating material with a part of the oxide of the metal oxide thin film by vacuum evaporation or vapor deposition or ion sputtering or plasma plating.

34. The manufacturing method according to claim 33, wherein:
the fusion region comprises nano heating material, a thickness of the fusion region is in a range of 0.01 µm to 10 µm, a thickness of the heating region is in a range of 1 µm to 20 µm, and a thickness of the metal oxide thin film region is in a range of 2 µm to 30 µm.

35. The manufacturing method according to claim 26, wherein the step of fixing an electrode paste to the electric heating layer is as follows:
the silver paste is screen printed and sintered to be fixed on the electric heating layer;
the sintering temperature is 120° C. to 600° C.;
and/or comprising the following steps:
fixing the insulating material on an outside of the electric heating layer by screen printing and sintering to as to form an electric insulating layer; and
fixing a negative temperature coefficient resistance material on the electric insulating layer by sintering so as to form a sintered coating.

36. The manufacturing method according to claim 26, wherein the nano heating material comprises at least one of TIO metal oxide nano heating material, In₂O₃ metal oxide nano heating material, ZnO metal oxide nano heating material, LiO metal oxide nano heating material, SnO₂ metal oxide nano heating material, Ca₂InO₄ metal oxide nano heating material, graphene nano heating material, and nano silver heating material.
